(19) United States
(12) Patent Application Publication
(10) Pub. No.: US 2017/0351751 A1
(43) Pub. Date: Dec. 7, 2017

(54) READING SUPPORT APPARATUS, COMPUTER-READABLE RECORDING MEDIUM, AND READING SUPPORT METHOD

(71) Applicant: FUJITSU LIMITED, Kawasaki-shi (JP)

(72) Inventors: Takeaki Terada, Kawasaki (JP); Satoru Torii, Yokohama (JP); Hiroshi Tsuda, Fujisawa (JP); Yoshinori Katayama, Kawasaki (JP)

(73) Assignee: FUJITSU LIMITED, Kawasaki-shi (JP)

(21) Appl. No.: 15/584,088

(22) Filed: May 2, 2017

(30) Foreign Application Priority Data
Jun. 1, 2016 (JP) 2016-110080

(51) Int. Cl. G06F 17/30; G06Q 50/18

(52) U.S. Cl. CPC G06F 17/30696; G06F 17/30864; G06Q 50/18

(57) ABSTRACT

A reading support apparatus is disclosed. The reading support apparatus includes a memory; and a processor coupled to the memory. The processor retains, in the memory, a provider address at which a document is registered. The processor monitors connection from a user with respect to the provider address retained in the memory. The processor acquires a word included in the document, the word reading support method used for a search conducted by the user in a state in which the user browses the document corresponding to the provider address, and outputs the word.

### CROSS-REFERENCE TO RELATED APPLICATIONS

This application is based upon and claims the benefit of priority of the prior Japanese Patent Application No. 2016-110080, filed on Jun. 1, 2016, the entire contents of which are incorporated herein by reference.

### FIELD

The embodiments discussed herein are related to a reading support apparatus, a computer-readable storage medium having stored therein a reading support program, and a reading support method.

### BACKGROUND

On the assumption of carefully reading sentences such as terms of service, a privacy policy, or the like to use an application, a Web service, or the like, users may be liable for users' responsibility if they violate the provisions. However, documents such as the terms of service are long and difficult to understand. The user feels confirmation as a burden and uses service or the like without fully understanding a usage condition. As a result, the user may suffer disadvantage later.

In a case of the terms of service for a Social Networking Service (SNS), there may be a case of including text to prohibit use of the SNS related to a business aim such that an event opening accompanying some kind of money transfer is disclosed to an unspecified number of people via the SNS. Such action may be intentionally conducted by an ordinary user. In a case in which the user does not carefully read and fully understand the terms of service, disadvantages may occur. In addition, as another example, in a plan selection of voluntary insurance of a car, there may be a case in which as a result of not carefully reading a contract, the user may misunderstand a meaning of interpersonal insurance, and the user may choose a plan that does not provide with a personal injury insurance (compensation for injured fellow passengers).

If descriptions such as the term and the like are ambiguous ones so that an interpretation thereof differs among people, a sentence creator may have a disadvantage in a case of a dispute about the interpretation. That is a reason why the descriptions are specified. As a result, the sentence becomes longer and difficult. However, for the sentence creator, it is preferable to minimize a cost to respond to a complaint and an inquiry from the user.

In contrast, technologies, which are not related to the contract, are known to devise a user interface of a screen, direct a user's attention to an important portion, and urge user's comprehension of a display content by an emphasis display or the like.

### PATENT DOCUMENTS

International Publication Pamphlet No. WO 03/103564

Japanese Laid-open Patent Publication No. 2010-55231

Japanese Laid-open Patent Publication No. 2014-63483

### SUMMARY

According to one aspect of the embodiments, a reading support apparatus includes a memory; and a processor coupled to the memory and the processor configured to retain, in the memory, a provider address at which a document is registered; monitor connection from a user with respect to the provider address retained in the memory; acquire a word included in the document, the word being used for a search conducted by the user in a state in which the user browses the document corresponding to the provider address; and output the word.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a system configuration example according to an embodiment;

FIG. 2 is a diagram illustrating a functional configuration example of a contract server;

FIG. 3 is a diagram illustrating a functional configuration example of an analysis server;

FIG. 4 is a diagram illustrating a functional configuration example of terminals;

FIG. 5 is a diagram illustrating a hardware configuration example for the contract server, the analysis server, and each of the terminals;

FIG. 6 is a diagram illustrating a process sequence for explaining a process example of the embodiment;

FIG. 7 a diagram illustrating a data example of a contract URL list;

FIG. 8 is a diagram illustrating a data example of a search engine URL list;

FIG. 9 is a diagram illustrating a data example of a contract word DB;

FIG. 10 is a diagram illustrating a data example of search logs;

FIG. 11 is a diagram illustrating a data example of aggregation logs;

FIG. 12 is a diagram illustrating an example of a portion-to-be-improved aggregation result; and

FIG. 13 is a diagram illustrating an example of a presentation of a portion to be improved.

### DESCRIPTION OF EMBODIMENTS

It is difficult to simplify description of a document such as a contract or the like, due to importance of contents and the like. Even for a user who attempts to thoroughly read the contract, it is difficult to comprehend the contents by reading it once. In contrast, a document creator does not have the viewpoint of the user. It is difficult for the document creator to know which portion is difficult for the user to understand. Also, opportunities to modify the contents of the contract to be a more understandable expression are limited for the document creator.

Accordingly, in one aspect of an embodiment, a scheme for outputting information to inform the document creator of the document about a portion predicted as being difficult to understand is provided below.

A preferred embodiment of the present invention will be described with reference to the accompanying drawings. It is noted that a contract as the sentence to be browsed will be described as an example. The embodiment is also applied to documents other than the contract.

<Configuration>

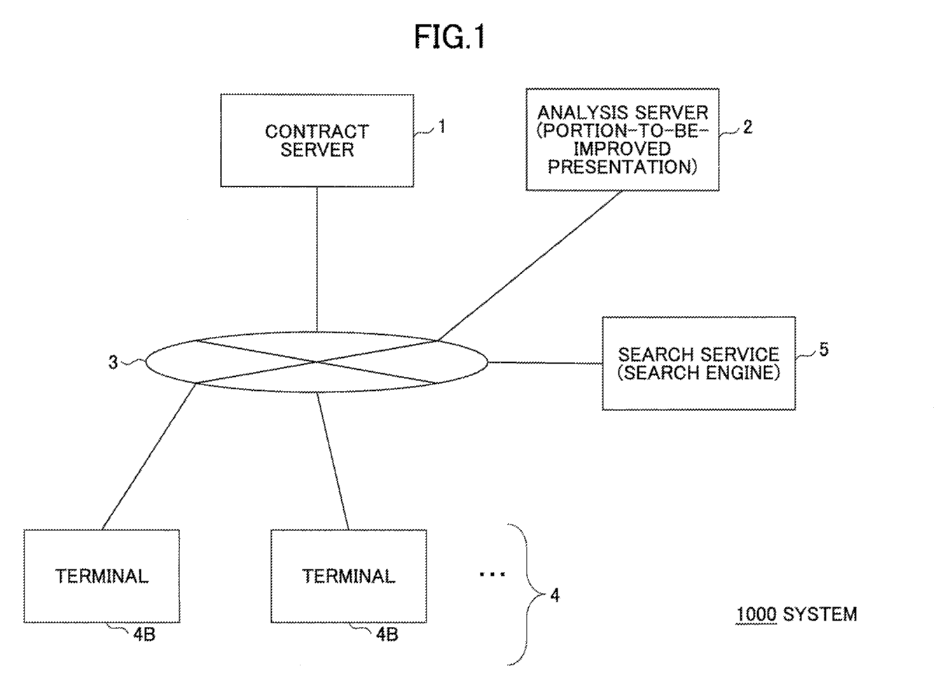

FIG. 1 is a diagram illustrating a system configuration example according to the embodiment. In FIG. 1, a system 1000 includes a contract server 1, an analysis server 2, and multiple terminals 4A, 4B, . . . , which are connected to a network 3 such as the Internet to communicate with each other. The contract server 1 provides information of the contract for a user to browse. The analysis server 2 supports the user to comprehend the contract. Each of the terminals 4A, 4B, . . . is used by the user to browse the contract. In addition, a search service (a search engine), which is operated by a portal site or the like, is provided via the network 3 for the terminals 4A, 4B, . . . to use. The terminals 4A, 4B, . . . may be collectively referred as the terminal 4.

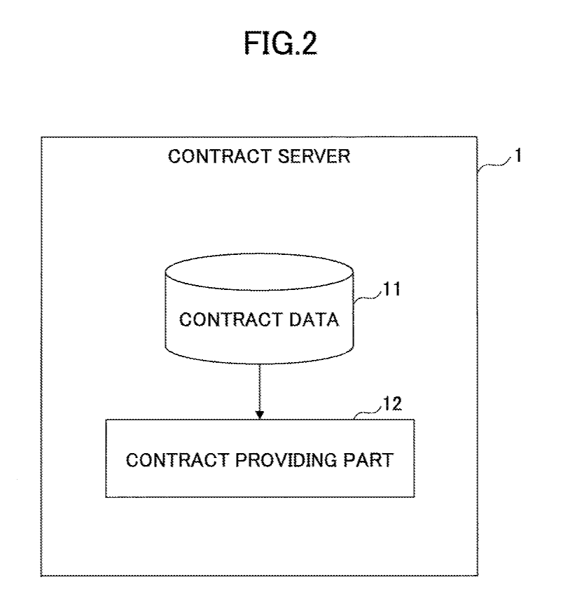

FIG. 2 is a diagram illustrating a functional configuration example of the contract server. In FIG. 2, the contract server 1 includes a contract providing part 12 for providing data of terms from contract data 11 in response to a request sent from each of the terminals 4 (4A, 4B, . . . ).

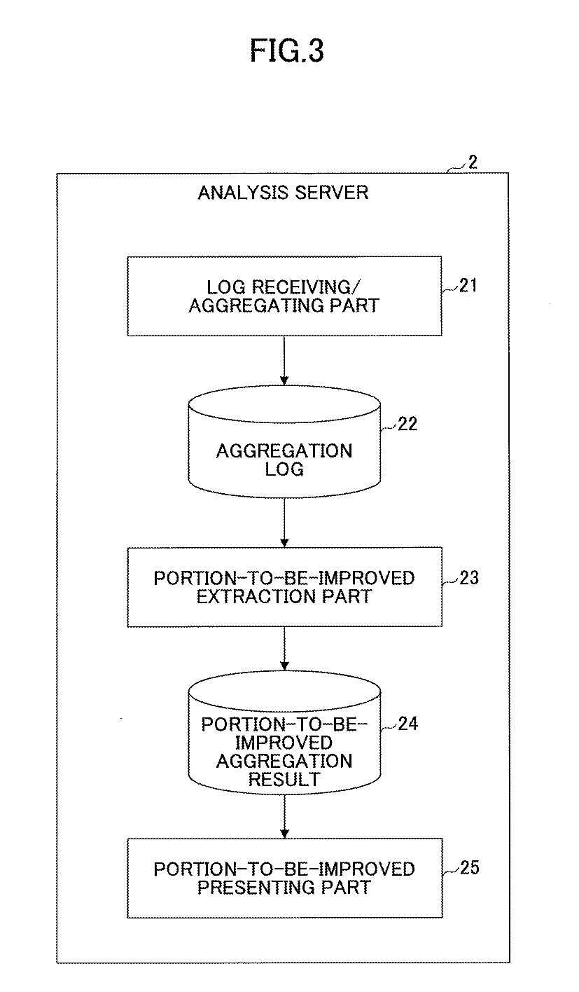

FIG. 3 is a diagram illustrating a functional configuration example of the analysis server. In FIG. 3, the analysis server 2 includes a log receiving/aggregating part 21, a portion-to-be-improved extraction part 23, and a portion-to-be-improved presenting part 25.

The log receiving/aggregating part 21 receives search logs 45 from the multiple terminals 4, and includes a function for outputting aggregation logs 22, in which the search logs 45 are aggregated for the multiple users. The portion-to-be-improved extraction part 23 includes a function for extracting portions searched multiple times as portions to be improved by aggregating and analyzing the portions to be improved based on the aggregation logs 22. The portion-to-be-improved presenting part 25 includes a function for presenting information of the portion to be improved to a contract creator (regarded as the document creator) for each of contracts retained in a portion-to-be-improved aggregation result 24.

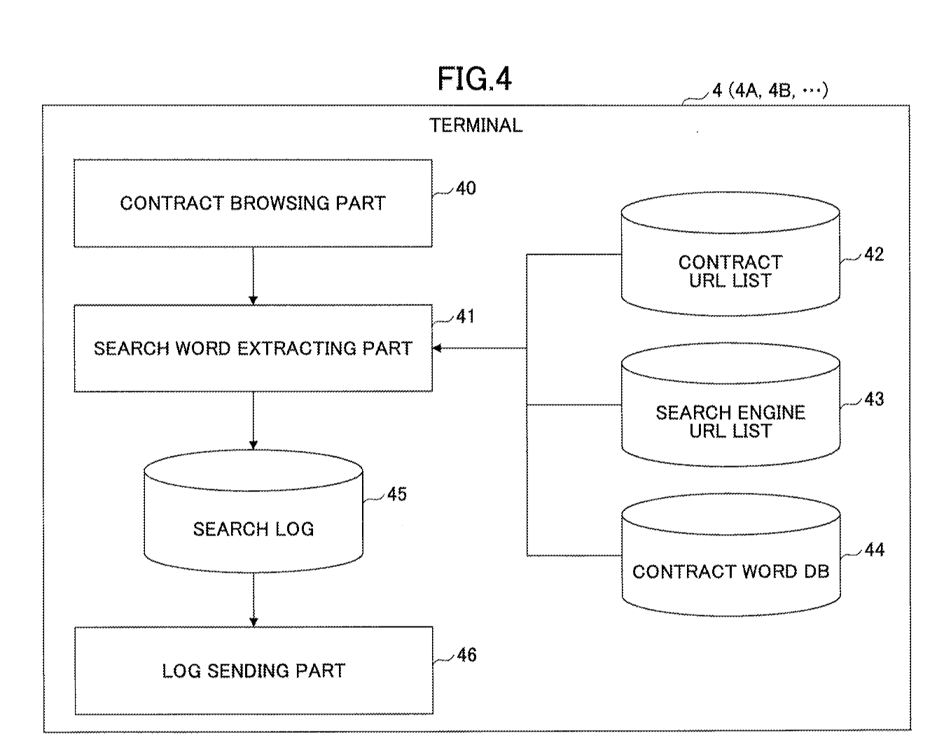

FIG. 4 is a diagram illustrating a functional configuration example of the terminals. In FIG. 4, each of the terminals 4 (4A, 4B, . . . ) includes a contract browsing part 40, a search word extracting part 41, and a log sending part 46.

The contract browsing part 40 includes a function for browsing the contract by accessing the contract server 1, and corresponds to a general purpose browser or a dedicated application. The search word extracting part 41 includes a function for monitoring a start-up of the contract browsing part 40, referring to a contract URL (Uniform Resource Locator) list 42, a search engine URL list 43, and a contract word Database (DB) 44.

(1) One of URLs listed in the contract URL list 42 is accessed by the contract browsing part 40. Or, a tab displaying a page of the URL is activated in the contract browsing part 40.

(2) The URL or the tab, which is activated by a next operation from the above item (1), is included in the search engine URL list 43.

(3) A searched word includes a term registered in the contract word DB 44. The term may be a word being meaningful by itself in the contract in a state of eliminating postpositional particles (“te”, “ni”, “wo”, and “ha” in Japanese), which immediately follow the modified noun, verb, adjective, or sentence.

The log sending part 46 includes a function for sending contents of the search logs 45 to the analysis server 2 at a predetermined timing.

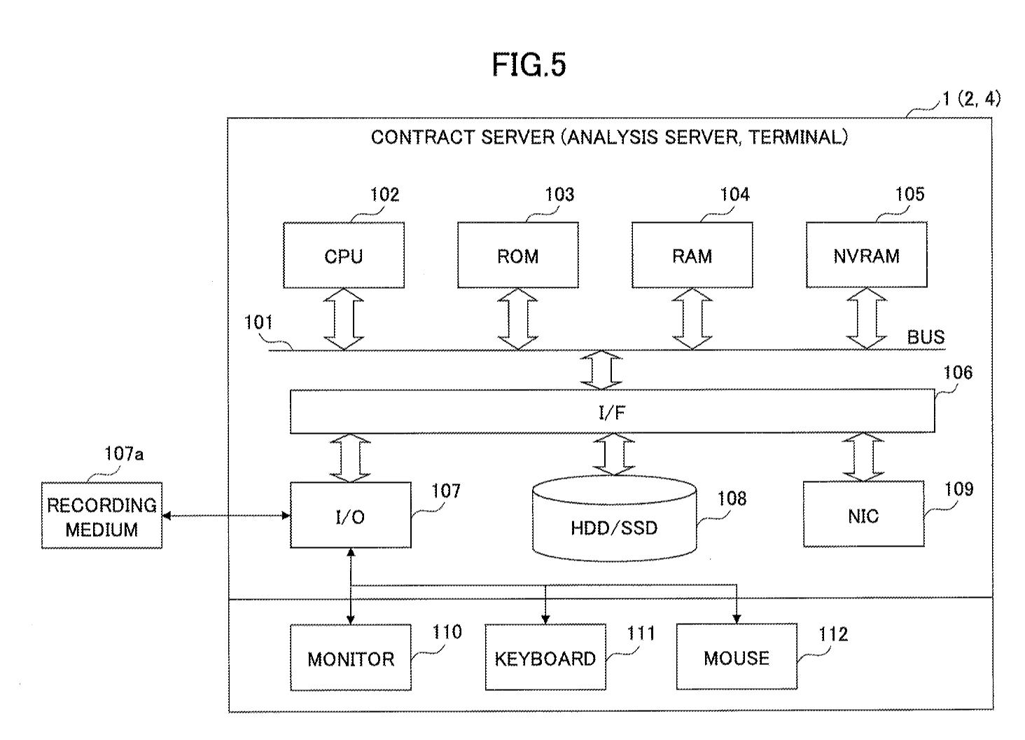

FIG. 5 is a diagram illustrating a hardware configuration example for the contract server, the analysis server, and each of the terminals. In FIG. 5, a hardware configuration will be described for the contract server 1. The hardware configuration of each of the analysis server 2 and the terminals 4 is similar to the hardware configuration of the contract server 1, and the explanation thereof will be omitted.

The contract server 1 includes a Central Processing Unit (CPU) 102, a Read Only Memory (ROM) 103, a Random Access Memory (RAM) 104, and a Non-Volatile Random Access Memory (NVRAM) 105, which are mutually connected via a bus 101. Also, the contract server 1 includes an InterFace (I/F) 106 connected to the bus 101, an I/O 107 as an Input/Output device, a Hard Disk Drive/Solid State Drive (HDD/SDD) 108, and a Network Interface Card (NIC) 109. Moreover, a monitor 110, a keyboard 111, a mouse 112, and the like are connected to the I/O 107. Instead of the keyboard 111 and the mouse 112, a touch panel may be implemented. As a recording medium, a Compact Disk/Digital Versatile Disk (CD/DVD) drive or the like may be connected to the I/O 107. A recording medium 107a may be any type of a recording medium, which is a non-transitory tangible computer-readable medium including a data structure. The recording medium 107a may be a non-transitory tangible computer-readable medium including a data structure such as a Compact Disc Read-Only Memory (CD-ROM), a Universal Serial Bus (USB) memory, or the like, or a semiconductor memory such as a flash memory.

The functions of the contract server 1 and the like described with reference to FIG. 2 through FIG. 4 are realized by the CPU 102 executing corresponding programs. The program may be acquired through the recording medium 107a, may be acquired via a network, or may be implemented beforehand in the ROM 103. More specifically, the program for operating the contract providing part 12 of the contract server 1 in FIG. 2 is stored in the HDD/SDD 108, is loaded in the RAM 104, and is executed by the CPU 102. The contract data 11 are temporarily retained in the RAM 104, and are permanently stored in the HDD/SDD 108.

Programs operating the log receiving/aggregating part 21, the portion-to-be-improved extraction part 23, and the portion-to-be-improved presenting part 25 of the analysis server 2 in FIG. 3 are stored in the HDD/SSD 108, and are loaded in the RAM 104 and executed by the CPU 102. The aggregation logs 22 and the portion-to-be-improved aggregation result 24 are temporarily retained in the RAM 104, and are permanently stored in HDD/SSD 108. The programs operating the contract browsing part 40, the search word extracting part 41, and log sending part 46 of each of the terminals 4 in FIG. 4 are stored in the HDD/SSD 108, are loaded in the RAM 104, and executed by the CPU 102. The contract URL list 42, the search engine URL list 43, the contract word DB 44, and the search logs 45 are temporarily retained in the RAM 104, and are permanently stored in the HDD/SSD 108.

<Operation>

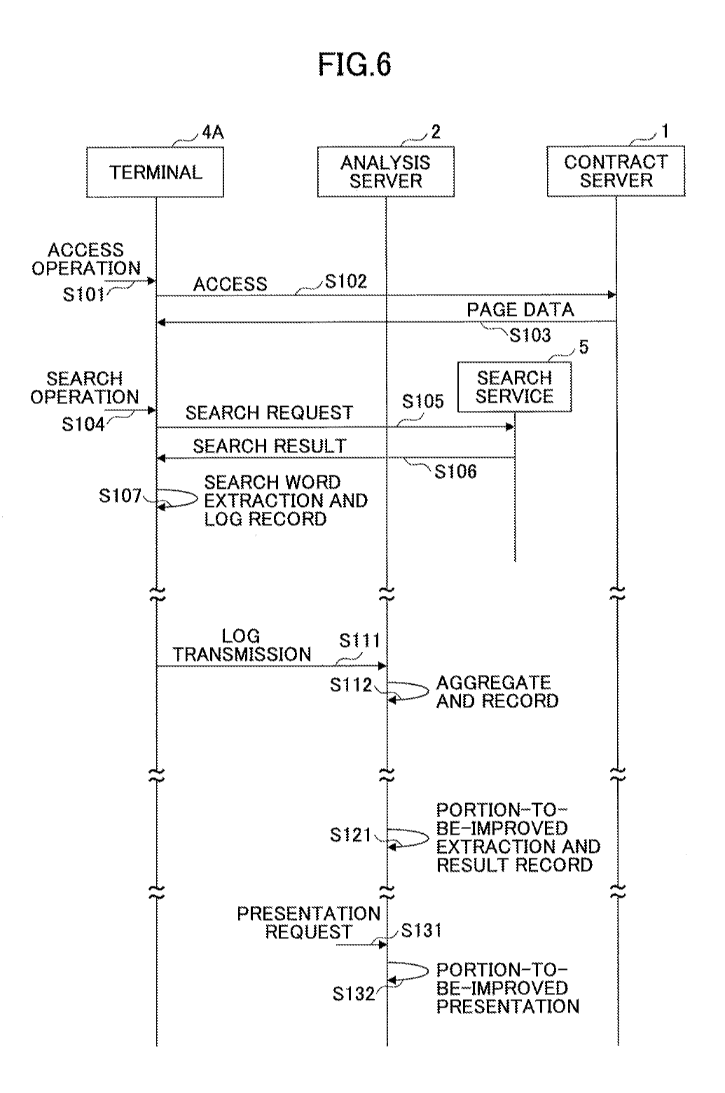

FIG. 6 is a diagram illustrating a process sequence for explaining a process example of the embodiment. In FIG. 6, when the user of the terminal 4A conducts an access operation such as an indication of the URL of a contract page, a link selection from another page, or the like with respect to the contract browsing part 40 (step S101), the contract browsing part 40 accesses the contract server 1 (step S102). The contract server 1 replies with page data of the contract (step S103), and the contract page is displayed at the terminal 4A.

The user reading the contract may have a question, when the user is not able to determine a meaning or a concrete example of the term in the contract. In such case, the user conducts a search operation in order to search by the search service 5 (step S104). The contract browsing part 40 sends a search request accompanying a search word with respect to the search service 5 (step S105). The search service 5 performs a search process in response to the search request, and sends a search result as a reply (step S106).

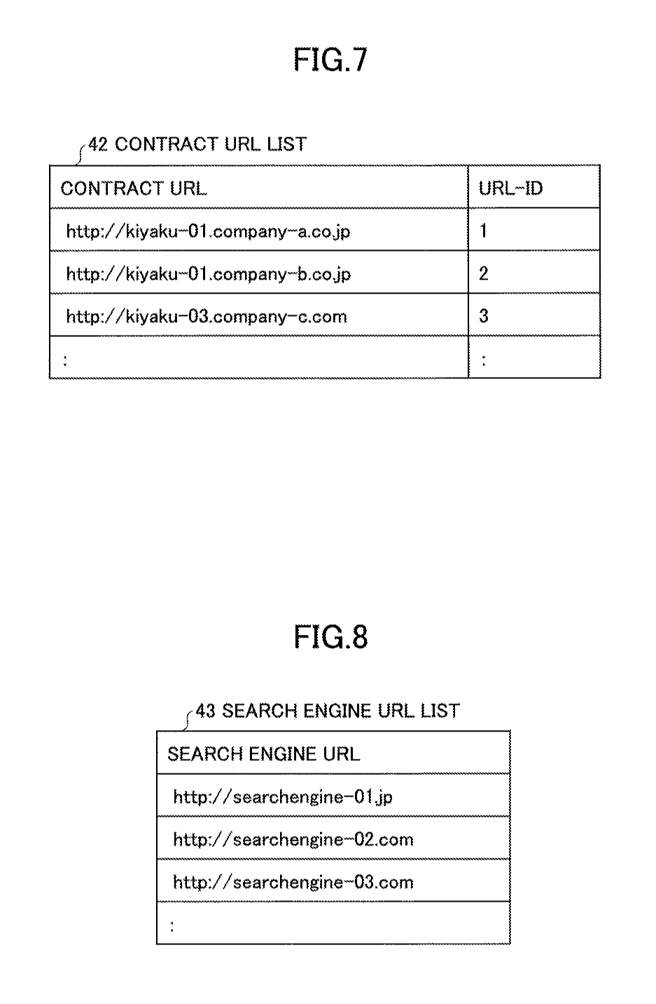

Information indicating such behavior pertinent to the searches of the user is monitored by the search word extracting part 41, and the search word is acquired and is recorded in the search logs 45 when a predetermined condition is satisfied (step S107). As the predetermined condition, first, before the search, it is determined whether one of URLs in the contract URL list 42 is accessed and whether the tab of the contract browsing part 40 displaying the page of the accessed URL becomes active. FIG. 7 illustrates a data example of the contract URL list. The contract URL list 42 retains the URL of the contract subject to be maintained.

As a next condition in a case in which the above described condition is satisfied, by an operation following the above described access, it is determined whether the activated URL or tab is included in the search engine URL list 43. FIG. 8 illustrates a data example of the search engine URL list. The search engine URL list 43 retains the URLs of the search engine (the search service) predicted to be used by the user.

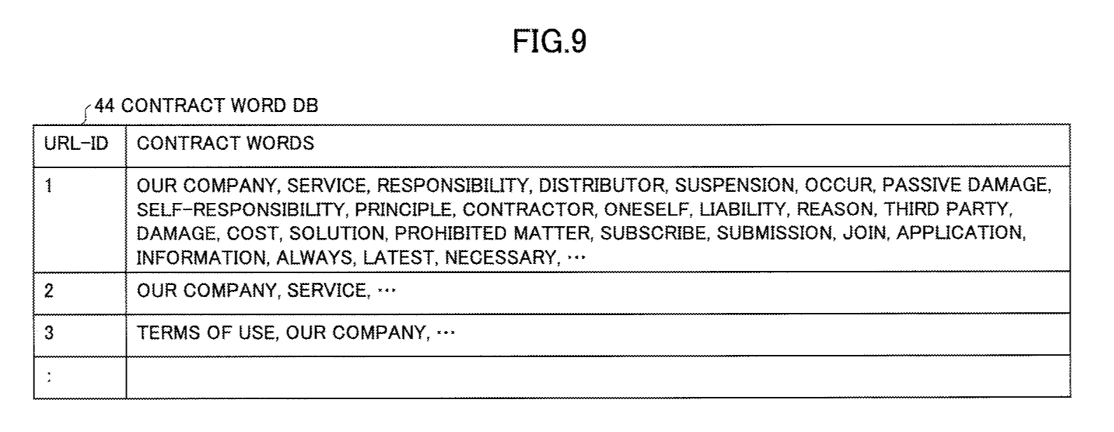

As a further next condition in a case in which the above described condition is satisfied, it is determined whether the search word entered in the search service includes the term being meaningful by itself in the contract in a state of eliminating postpositional particles (“te”, “ni”, “wo”, and “ha” in Japanese), which is registered in the contract word DB 44. FIG. 9 is a diagram illustrating a data example of the contract word DB. The contract word DB 44 stores the terms included in the contract as the contract words for each of URL-IDs identifying the contracts.

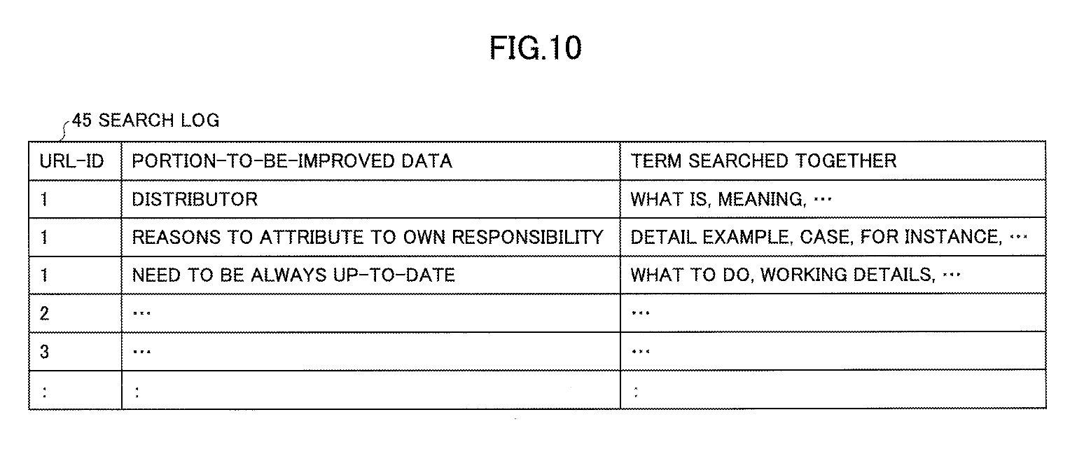

When all these conditions are satisfied, the search word extracting part 41 records the search logs 45. FIG. 10 is a diagram illustrating a data example of the search logs. For each of the URL-IDs identifying the contracts, the contract word included in the search word is recorded as “portion-to-be-improved data”. Also, words entered together at the search are recorded as a “term searched together”. In a case in which a logical operator is used for the search, the logical operator is also included in the “term searched together”.

Referring to FIG. 6, after the above process, at the predetermined timing, the log sending part 46 sends a content of the search log 45 with a user ID to the analysis server 2 (step S111). The predetermined timing may be every time data are output to the search log 45, an end of a process of the contract browsing part 40, a predetermined interval, or the like.

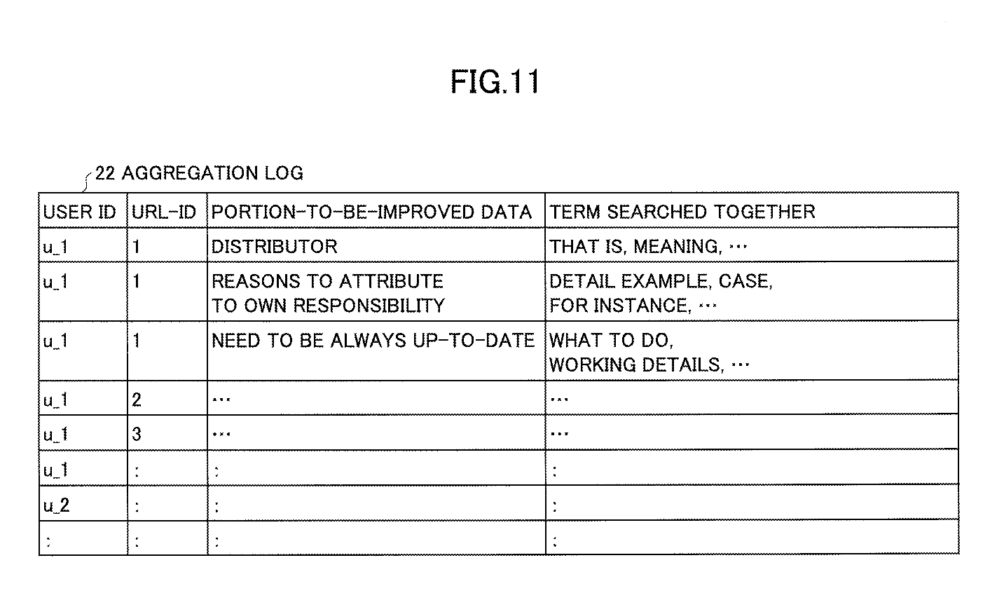

When the log receiving/aggregating part 21 of the analysis server 2 receives a log, multiple logs are aggregated, and are output to the aggregation logs 22 (step S112). FIG. 11 is a diagram illustrating a data example of the aggregation logs. The user ID is additionally provided to a content being similar to the search log 45 illustrated in FIG. 10, and the content is stored as the aggregation logs 22.

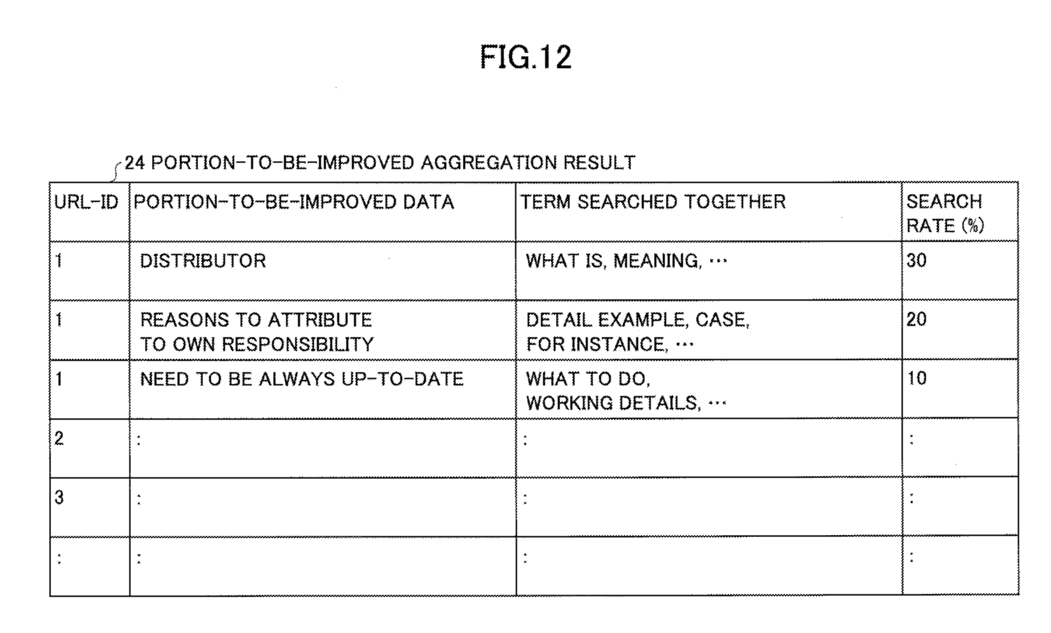

Referring to FIG. 6, the portion-to-be-improved extraction part 23 of the analysis server 2 extracts a portion, which is searched the most, by aggregating and analyzing the portion to be improved based on the aggregation logs 22 at the predetermined timing (step S121). That is, based on multiple sets of information of the portions to be improved for a plurality of users, the portion-to-be-improved extraction part 23 merges the information for each of the portions to be improved. FIG. 12 is a diagram illustrating an example of the portion-to-be-improved aggregation result. For each of the URL-IDs identifying the contracts, a “portion-to-be-improved data”, a “term searched together”, and a “search rate (%)” are recorded. The contract word included in the search word is recorded in the “portion-to-be-improved data”. In the “term searched together”, data are formed by merging words being searched together with the contract word recorded in the “portion-to-be-improved data”. The “search rate (%)” indicates a proportion of a count of the users conducting the search including that contract word for each of contract IDs with respect to a total count of the users conducting the search.

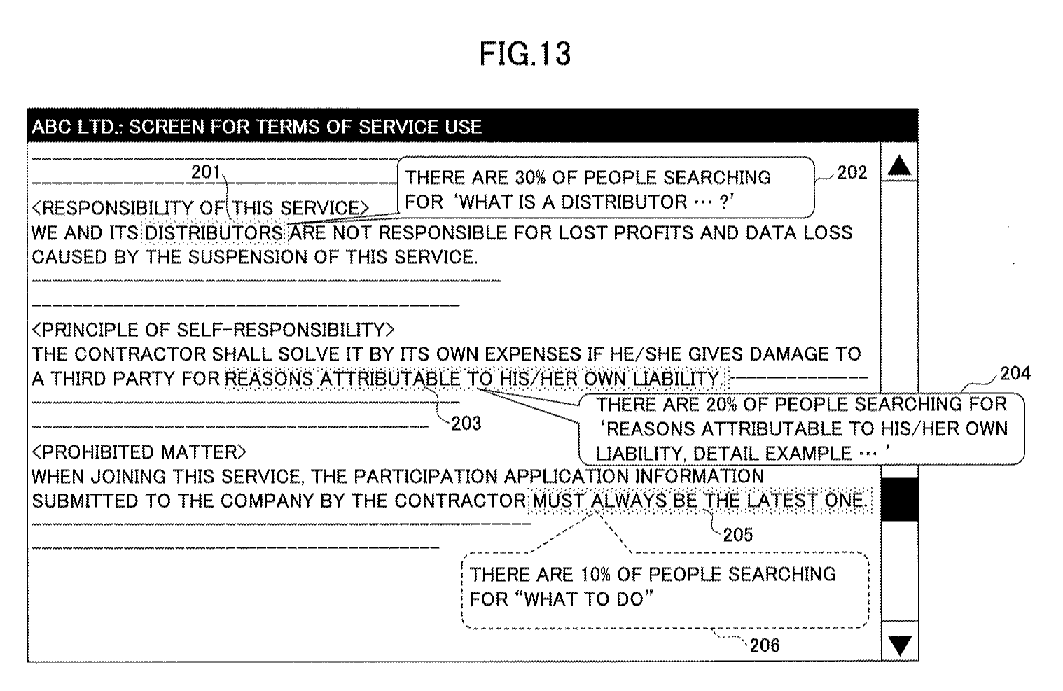

Back to FIG. 6, after the above described process, when the contract creator (regarded as the document creator) conducts a presentation request of the portion to be improved by indicating the contract (step S131), the portion-to-be-improved presenting part 25 acquires and presents information of the contract (the contract ID) from the portion-to-be-improved aggregation result 24 (step S132). FIG. 13 is a diagram illustrating an example of a presentation of the portion to be improved. This example corresponds to the portion-to-be-improved aggregation result 24 illustrated in FIG. 12. That is, in FIG. 13, with respect to a letter string portion 201 of “distributors”, the letter string portion 201 may be emphasized by color such as red, and a comment may be displayed in a popup 202 such that “There are 30% of peoples searching for ‘What is a distributor . . . ?’”. Also, with respect to a letter string portion 203 of “reasons attributable to his/her own liability”, similarly, the letter string portion 203 may be emphasized by color such as red, and a comment may be displayed in a popup 204 such that “There are 20% of peoples searching for ‘reasons attributable to his/her own liability, detail example . . . ’”.

It is noted that a highly important letter string portion, which is displayed in red in order to attract attention, may correspond to a portion where the search rate is greater than or equal to a predetermined value (preferably, 20%) in the portion-to-be-improved aggregation result 24 (FIG. 12). Other letter string portions may be displayed in a yellow popup. In FIG. 13, with respect to a letter string portion 205 of “must always be the latest one”, the letter string portion 205 may be emphasized by yellow, and a comment may be displayed in a popup 206 such that “There are 20% of peoples searching for ‘reasons attributable to his/her own liability, detail example . . . ’”.

The contract creator browses the presentation of the portion to be improved to concretely comprehend which portion is difficult to understand. Based on this comprehension, it is possible for the contract creator to modify the contract later.

<General Overview>

As described above, according to the embodiment, based on the search conducted by the user in the course of reading the document such as the contract or the like, the information pertinent to a difficult word in the document is provided to the document creator, and gives a chance of modifying the document to the document creator. Accordingly, it is possible to output information to inform the document creator of the portion predicted as being difficult to understand in the document.

The contract URL list 42 is an example of “retaining an address”. The search word extracting part 41 is an example of “acquiring a word”. The portion-to-be-improved presenting part 25 is an example of “outputting the word”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A reading support apparatus comprising:
a memory; and
a processor coupled to the memory and the processor configured to
retain, in the memory, a provider address at which a document is registered;
monitor connection from a user with respect to the provider address retained in the memory;
acquire a word included in the document, the word being used for a search conducted by the user in a state in which the user browses the document corresponding to the provider address; and
output the word.

2. The reading support apparatus as claimed in claim 1, wherein the word is acquired in a case of transitioning from a first state of browsing the document from a connection destination of a first group to a second state of using a search service of a connection destination of a second group, and a case in which the search word input to the search service includes one word in a word group registered for each of documents.

3. The reading support apparatus as claimed in claim 2, wherein the one word included in the word group is acquired with another word simultaneously used for a search.

4. The reading support apparatus as claimed in claim 1, wherein the word being used for the search is output in a descending order of a proportion of a count of users conducting the search for each of words with respect to a total count of the users conducting searches.

5. The reading support apparatus as claimed in claim 4, wherein a predetermined number of words having a high proportion are output by applying a color for attracting attention.

6. A non-transitory computer-readable recording medium storing therein a reading support program that causes a computer to execute a process comprising:
monitoring connection from a user with respect to a provider address at which a document is registered;
acquiring a word included in the document, the word being used for a search conducted by the user in a state in which the user browses the document corresponding to the provider address; and
outputting the word.

7. The non-transitory computer-readable recording medium as claimed in claim 6, wherein the word is acquired in a case of transitioning from a first state of browsing the document from a connection destination of a first group to a second state of using a search service of a connection destination of a second group, and a case in which the search word input to the search service includes one word in a word group registered for each of documents.

8. The non-transitory computer-readable recording medium as claimed in claim 7, wherein the one word included in the word group is acquired with another word simultaneously used for a search.

9. The non-transitory computer-readable recording medium as claimed in claim 6, wherein the word used for the search is output in a descending order of a proportion of a count of users conducting the search for each of words with respect to a total count of the users conducting searches.

10. The non-transitory computer-readable recording medium as claimed in claim 9, wherein a predetermined number of words having a high proportion are output by applying a color for attracting attention.

11. A reading support method by a computer, comprising:
monitoring connection from a user with respect to a provider address at which a document is registered;
acquiring a word included in the document, the word being used for a search conducted by the user in a state in which the user browses the document corresponding to the provider address; and
outputting the word.

12. The reading support method as claimed in claim 11, wherein the word is acquired in a case of transitioning from a first state of browsing the document from a connection destination of a first group to a second state of using a search service of a connection destination of a second group, and a case in which the search word input to the search service includes one word in a word group registered for each of documents.

13. The reading support method as claimed in claim 12, wherein the one word included in the word group is acquired with another word simultaneously used for a search.

14. The reading support method as claimed in claim 11, wherein the word being used for the search is output in a descending order of a proportion of a count of users conducting the search for each of words with respect to a total count of the users conducting searches.

15. The reading support method as claimed in claim 14, wherein a predetermined number of words having a high proportion are output by applying a color for attracting attention.
